(19) United States
(12) Patent Application Publication
(10) Pub. No.: US 2017/0167791 A1
(43) Pub. Date: Jun. 15, 2017

(54) POWDER SINTERING SYSTEM

(71) Applicants: JIANGSU HUADONG INSTITUTE OF LI-ION BATTERY CO., LTD., Suzhou (CN); TSINGHUA UNIVERSITY, Beijing (CN)

(72) Inventors: Xiang-Ming He, Beijing (CN); Jian-Jun Li, Beijing (CN); Jian-Li Zhang, Beijing (CN); Li Wang, Beijing (CN); Yu-Ming Shang, Beijing (CN); Cheng-Hao Xu, Beijing (CN); Jing Luo, Beijing (CN); Jian Gao, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/442,520

(22) Filed: Feb. 24, 2017

Related U.S. Application Data
(63) Continuation of application No. PCT/CN2014/091941, filed on Nov. 21, 2014.

(30) Foreign Application Priority Data
Aug. 29, 2014 (CN) 201410433995.0

(51) Int. Cl. F27D 3/00; H01M 4/04; F27B 15/10; F27B 17/02; F27B 15/00; F27B 15/14; F27B 15/09; F27D 7/06; H01M 4/1391; F27B 15/08

(52) U.S. Cl. CPC F27D 3/0033; H01M 4/1391; H01M 4/0471; F27B 15/10; F27B 15/08; F27B 15/003; F27B 15/14; F27B 15/09; F27D 7/06; F27B 17/02; F27D 2003/0077

(57) ABSTRACT

A powder sintering system is disclosed. The powder sintering system includes a furnace body, at least one first dispersing device, at least one second dispersing device, a heating device, and a gas introducing device. The furnace body includes a bottom and a side wall defines a funnel shaped chamber. The at least one first dispersing device is located on the bottom of the furnace body, and disperses powder from the bottom of the furnace body to the side wall of the furnace body. The at least one second dispersing device is located on the side wall of the furnace body, and centrifugally disperse powder from the side wall of the furnace body to a center of the funnel shaped chamber. The heating device is located outside the furnace body. The gas introducing device supplies a protecting gas into the funnel shaped chamber.

### CROSS-REFERENCE TO RELATED APPLICATIONS

This application claims all benefits accruing under 35 U.S.C. §119 from China Patent Applications No. 201410433995.0, filed on Aug. 29, 2014 in the State Intellectual Property Office of China, the content of which is hereby incorporated by reference. This application is a continuation under 35 U.S.C. §120 of international patent application PCT/CN2014/091941 filed on Nov. 21, 2014, the content of which is also hereby incorporated by reference.

### FIELD

The present disclosure relates to powder sintering systems and, particularly, to a powder sintering system under an atmospheric protection condition.

### BACKGROUND

Powder usually refers to a collection of discrete, small solid particles. Airborne powder can cause great harm to those exposed to the airborne powder over a long term. Sintering can fuse the collection of discrete particles into a material or product of crystalline combination, to make effective use of the powder, and reduce the risk of environment pollution.

Powder sintering systems generally involve a static sintering process. In a static sintering process, because the powder is stacked, the sintering temperature difference inside the stacked powder and outside of the stacked powder can be significant. The unevenly mixed powder could result in powder not fully sintered. Thus, the product yield of the powder sintering is relatively low.

### BRIEF DESCRIPTION OF THE DRAWINGS

Implementations are described by way of example only with reference to the attached figures.

FIG. 1 is a cross-sectional view of one embodiment of a powder sintering system.

FIG. 2 is a schematic structural view of a first dispersing device of one embodiment of the powder sintering system.

FIG. 3 is a top view of the first dispersing device in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

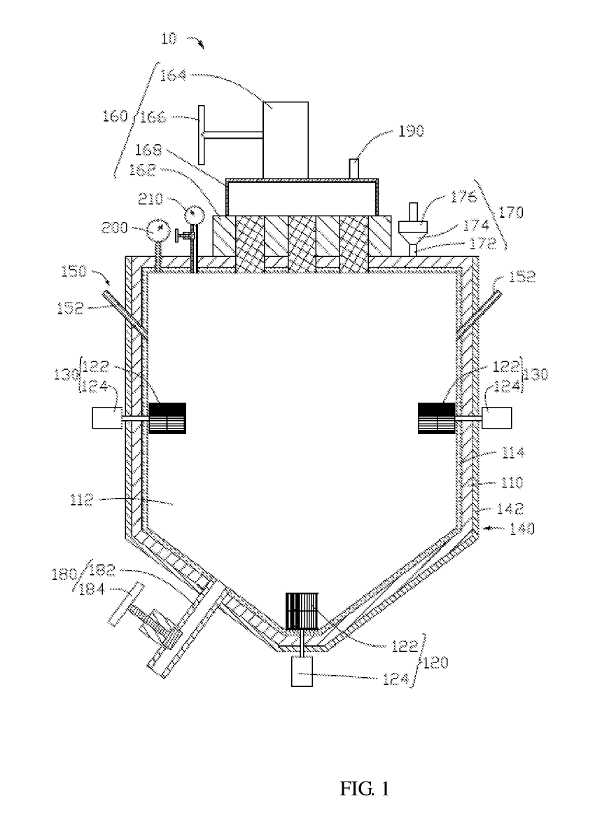

Referring to FIG. 1, one embodiment of a powder sintering system 10 is disclosed. The powder sintering system 10 includes a furnace body 110, a first dispersing device 120, a second dispersing device 130, a heating device 140, a gas introducing device 150, an exhaust device 160, a feed device 170, and a discharge device 180.

The furnace body 110 defines a funnel shaped chamber 112 with a closed structure. An upper portion of the furnace body 110 can be a hollow column shaped structure, a hollow cone shaped structure, or a hollow frustum shaped structure, etc. A lower portion of the furnace body 110 can be a hollow frustum shaped structure. In one embodiment, the upper portion of the furnace body 110 has a hollow column shaped structure, and the lower portion of the furnace body 110 has a hollow frustum shaped structure. The hollow column shaped structure and the hollow frustum shaped structure are connected together to form the funnel shaped chamber 112. The hollow column shaped structure can be a hollow cylinder or a hollow prism. The hollow prism can be a hollow quadrangular prism, a hollow pentagonal prism, or a hollow hexagonal prism. The hollow frustum structure can be a hollow conical frustum or a hollow pyramidal frustum which cooperates with the hollow cylinder or hollow prism. When the hollow prism is a hollow quadrangular prism, a hollow pentagonal prism or a hollow hexagonal prism, the hollow pyramidal frustum can also be quadrangular, pentagonal or hexagonal, respectively, to match the shape of the hollow prism.

In one embodiment, the upper portion of the furnace body 110 can be a hollow cylinder and the lower portion of the furnace body 110 can be a hollow conical frustum. A material of the furnace body 110 can be selected from heat resistance materials. A surface coating layer 114 can be coated on an inner wall of the furnace body 110 to prevent powder from adhering to the inner wall of the furnace body 110 during sintering. The surface coating layer 114 can be a ceramic-based coating, a graphite-based coating, a polytetrafluoroethylene coating, or other high temperature resistant coatings. The surface coating layer 114 can prevent the introduction of metallic impurities such as iron and make the production process cleaner.

The first dispersing device 120 can be configured to centrifugally disperse the powder at the bottom of the furnace body 110 to the side wall of the furnace body 110, thereby improving the mixing of the powder uniformly. That is, the powder is propelled by the spinning of the first dispensing device 120. The number of the first dispersing devices 120 can be one or more according to actual needs. The first dispersing device 120 is located at the bottom of the furnace body 110. In some embodiments, a single first dispersing device 120 is located at a center of the bottom of the furnace body 110. In one embodiment, one first dispersing device 120 is disposed at the center of the bottom surface of the hollow frustum structure.

The second dispersing device 130 can be configured to centrifugally disperse powder at the side wall of the furnace body 110 to the funnel shaped chamber 112. That is, the powder is propelled by the spinning of the second dispensing device 130. In one embodiment, the second dispersing device 130 can disperse the powder from the side wall of the furnace body 110 to a central axis position of the funnel shaped chamber 112. The number of the second dispersing devices 130 can be one or more according to actual needs. The second dispersing device 130 can be located on the side wall of the furnace body 110. In one embodiment, the second dispersing device 130 can be located on the side wall of the furnace body 110 and closer to a top of the furnace body 110.

When the number of the second dispersing devices 130 is two or more, the second dispersing devices 130 can be located at the same height or at different heights on the side wall of the furnace body 110. The second dispersing devices 130 can be located opposite each other, opposite each other and offset a certain distance, or provided anywhere along the side wall of the furnace body 100. In one embodiment, the second dispersing devices 130 can be disposed at the same height on the side wall of the furnace body 110. In another embodiment, the second dispersing devices 130 are at the same height on the side wall of the furnace body 110. In yet another embodiment, the second dispersing devices 130 are at the same height opposite each other as one or more pairs with respect to the central axis of the furnace body 110. The location of the dispersing devices 120, 130 of the powder sintering system 10 can be arranged to be more conducive to adjust and accommodate the movement trajectory of the powder in the furnace body 110. When the second dispersing devices 130 are located at different heights on the sidewall of the furnace body 110, the distribution of the powder can be controlled by adjusting the rotational speed of the two or more second dispersing devices 130 individually. In one embodiment, two second dispersing devices 130 can be disposed at the same height on the side wall of the hollow cylinder, and arranged opposite to each other with respect to the central axis of the funnel shaped chamber 112.

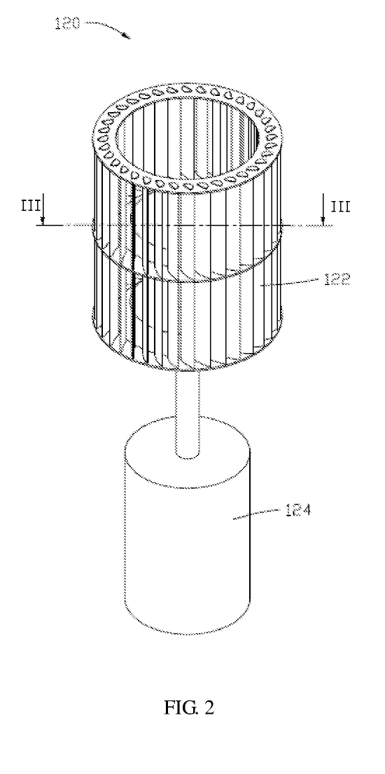

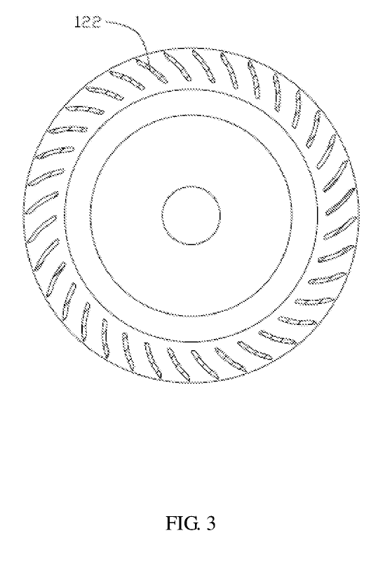

Referring to FIGS. 2 and 3, the first dispersing device 120 includes a dispersing wheel 122, an actuator 124, and a circuit controller (not shown). The dispersing wheel 122 is located inside the furnace body 110 and used for centrifugally dispersing the powder in the furnace body 110. A material of the dispersing wheel 122 can be a high temperature resistant material such as a ceramic or a stainless steel alloy. A rotational speed of the dispersing wheel 122 can be in a range from about 0 to about 20000 r/min. In one embodiment, the rotational speed of the dispersing wheel 122 can be in a range from about 2000 to about 10000 r/min. The speed range is not only conducive to effectively centrifugally disperse the powder to mix the powder uniformly, but also to improve stability of the powder sintering system 10, and reduce energy consumption.

The actuator 124 is located outside the furnace body 110 for driving the dispersing wheel 122 to rotate at a constant rotational speed. The actuator 124 can be a magnetically coupled actuator, a motor control actuator, or a mechanical actuator. The circuit controller is connected to the actuator 124 and provides power to the actuator 124. In one embodiment, a rotation axis of the dispersing wheel 122 of the first dispersing device 120 is parallel to a center axis of the funnel shaped chamber 112. The dispersing wheel 122 is a hollow cage type agitator. When the dispersing wheel 122 rotates with a high speed, a negative pressure is generated at center of the dispersing wheel 122, and the powder can be moved away around the dispersing wheel 122.

The dispersing wheel 122 can comprise a plurality of fins sandwiched between two rings and arranged around an axis of the dispersing wheel 122. The fins can be straight, curved, or specially shaped to engage the powder by striking the powder and propelling the powder away from the dispersing wheel 122. The fins can have a thin profile and be angled radially, tangentially, or both radially and tangentially relative to the axis of the dispersing wheel 122. As shown in FIG. 2, the fins are curved and spaced equidistantly around the axis of the dispersing wheel. The fins and rings of the dispersing wheel 122 may also be stacked on top of another to form a longer dispersing wheel 122 so that thinner profile fins can be used, as shown in FIG. 3.

A structure, material, and rotational speed of the second dispersing device 130 can be the same as a structure, material, and rotational speed the first dispersing device 120 as described above, respectively, except that a rotation axis of the dispersing wheel 122 of the second dispersing device 130 is perpendicular or at an angle to the central axis of the funnel shaped chamber 112.

The heating device 140 includes a heating element 142 and a thermocouple (not shown). The heating element 142 is located outside the furnace body 110 for heating the furnace body 110. The heating device 140 can heat the furnace body 110 to raise the temperature of the funnel shaped chamber 112 within a range from about 100° C. to about 1300° C. In one embodiment, the heating element 142 of the heating device 140 is a resistance wire wound around an outer surface of the furnace body 110. The thermocouple is located inside the funnel shaped chamber 112 for detecting the temperature of the funnel shaped chamber 112.

In one embodiment, the heating device 140 can further include a protecting layer (not shown) and a thermal insulating layer (not shown). The thermal insulating layer and the protecting layer can be sequent coated on an outer surface of the heating element 142.

The gas introducing device 150 is configured to input a protecting gas into the funnel shaped chamber 112. The protecting gas can be an oxidizing gas, a reducing gas, or an inert gas. The gas introducing device 150 can include a plurality of intake pipes 152 and a gas supply device (not shown) connected to the intake pipes 152. The intake pipes 152 can be located on the side wall of the furnace body 110 between the top of the furnace body 110 and the second dispersing device 130, and opposite each other. Each of the intake pipes 152 includes an inlet and an outlet. The position and arrangement of the outlets of the intake pipes 152 are not limited. In one embodiment, the outlets of the intake pipes 152 are located on the side wall of the of the furnace body 110 between the top of the furnace body 110 and the second dispersing device 130. In one embodiment, the intake pipes 152 are angled towards or away from the first dispensing device 120 in a direction that forms an angle with the center axis of the funnel shaped chamber 112 in a range greater than 0 degrees and less than 90 degrees. The advantage of this arrangement is that the trajectory of movement of the powder in the funnel shaped chamber 112 can be adjusted to achieve a combination of uniform mixing and thorough powder sintering. The angle of the pipe intake 152 can also be in a range from about 30 degrees to about 60 degrees. In one embodiment, the angle of the pipe intake 152 is about 45 degrees. The number of intake pipes 152 can be set according to the number of the second dispersion devices 130. In one embodiment, one intake pipe 152 is located on the side wall of the furnace body 110 between each of the second dispersion devices 130 and a top of the furnace body 110. In order to prevent the intake pipe 152 from being damaged at a high temperature, a high temperature resistant filter can be located at the outlet of each of the at least two intake pipes 152. In one embodiment, the gas introducing device 150 can include one intake pipe 152.

The exhaust device 160 is configured to promptly discharge sintered products such as hot smoke and gas in the sintering process. The exhaust device 160 can include a gas-solid separating unit 162, an exhaust pipe 164, an automatic control valve 166, and a gas buffer unit 168. The gas-solid separating unit 162 is located on the top of the furnace body 110 for preventing clogging of the exhaust pipe 164. The gas-solid separating unit 162 can include heat resistance elements such as a gas-solid separator, a filter screen, and a pulsed reverse-inflating element. The gas buffer unit 168 is located on one end of the gas-solid separating unit 162 away from the furnace body 110. The exhaust pipe 164 is located on one end of the gas buffer unit 168 away from the gas buffer unit 168. The automatic control valve 166 is disposed on the exhaust pipe 164. The automatic control valve 166 can automatically open the exhaust pipe 164 when the pressure inside the funnel shaped chamber 112 exceeds a set value.

The feed device 170 can be located on the top of the furnace body 110. The powder is charged into the furnace body 110 via the feed device 170, and dropped to the bottom of the furnace body 110 by its own weight. The feed device 170 can include a feed pipe 172, a tapered container 174, and a butterfly valve (not shown). The butterfly valve is located between the feed pipe 172 and the tapered container 174. The tapered container 174 is connected to the funnel shaped chamber 112 through the feed pipe 172. The feed device 170 can further include a gas exchanging room 176 for removing oxygen gas inside the powder and saturating the powder with a protective gas such as a nitrogen gas. The gas exchanging room 176 is located on one end of the tapered container 174 remote from the furnace body 110. After the gas in the powder is repeatedly exchanged in the gas exchanging room 176, the powder can be transferred into the tapered container 174 by means such as a flapping pad, and temporarily stored in the tapered container 174. During the feeding, the powder is transferred from the tapered container 174 into the feed pipe 172 through the butterfly valve, and fed gradually into the funnel shaped chamber 112 through the feed pipe 172.

The discharge device 180 is located on a lower portion of the side wall of the furnace body 110 for outputting the sintered powder from the funnel shaped chamber 112. The discharge device 180 can include a discharge pipe 182 and a control valve 184. The control valve 184 is located on the discharge pipe 182. When the powder is to be discharged after the sintering of the powder is completed, the control valve 184 is opened to discharge the sintered powder out the funnel shaped chamber 112 under the force of gravity, a supply gas, vacuum, or a combination of forces. It is to be understood that the number of feed devices 170 and discharge devices 180 each can be two or more.

The powder sintering system 10 can further include a vacuuming device 190 for drawing out the air in the funnel shaped chamber 112. In one embodiment, the vacuuming device 190 is located at one end of a gas-solid separating unit 162 remote from the furnace body 110.

The powder sintering system 10 can further include a pressure sensing device 200 and/or a gas testing device 210. The pressure sensing device 200 is used for detecting the gas pressure in the funnel shaped chamber 112. The gas testing device 210 is used for detecting the gas components in the funnel shaped chamber 112. The pressure detection device 200 and the gas detection device 210 can be located on top of the furnace body 110.

The powder sintering system 10 can further include a viewing window (not shown) to facilitate viewing of the state of the powder in the funnel shaped chamber 112. The viewing window can be located on the sidewall or the top of the furnace body 110.

The powder sintering system 10 can be used for preparing a cathode active material or an anode active material of a lithium ion battery, which are mainly lithium transition metal composite oxides, such as lithium iron phosphate, lithium cobalt oxide, lithium manganese oxide, lithium nickel oxide, and lithium titanate.

A work principle of the powder sintering system 10 is explained as follows. The funnel shaped chamber 112 is evacuated before powder sintering. When a vacuum degree in the funnel shaped chamber 112 reaches a certain level, the evacuation is stopped. The protective gas such as nitrogen gas is supplied to the funnel shaped chamber 112 until the gas content in the funnel shaped chamber 112 satisfies a technical requirement through the testing of the gas detection device 210. After the gas in the powder is repeatedly exchanged in the gas exchanging room 176, the powder is transferred into the tapered container 174. The powder is then gradually fed into the funnel shaped chamber 112 through the feed pipe 172. The powder can drop to the bottom of the furnace body 110 under its own weight. When the powder reaches the first dispersing device 120, the powder is dispersed away from the spinning first dispensing device 120 by the first dispensing device 120, and propelled to the side wall of the furnace body 110, with the powder spirally raised along the side wall of the furnace body 110. The powder on the side wall of the furnace body 110 is sintered via heating by the heating device 140. If the powder reaches the second dispersing device 130, the powder is again moved away by the spinning second dispersing device 130 and thrown towards the center of the funnel shaped chamber 112. The tossed powder returns to the first dispensing device 120 falling under the action of its own weight or directly from the second dispersing device 130 and is again propelled and dispersed by the first dispensing device 120, thus forming a cycling process. Therefore, the first dispersing device 120 and the second dispersing device 130 work together to evenly mix the powder and sinter the powder.

The powder sintering system provided in the present disclosure has the following characteristics. First, the dynamic sintering of the powder inside the furnace body can be realized by rationally arranging the dispersing device so that the powder can be uniformly dispersed in the sintering process. Second, through cooperation of the dispersion device, the gas introducing device, and the exhaust device, a large-scale industrial production of continuous production can be realized, and the consistency of powder sintered products can be greatly improved. Third, in the powder sintering process, only the intake pipe, the exhaust pipe, and the feed pipe communicate with the outside environment, which makes the powder sintering system sealed well. Fourth, the introduction of the protective gas can be stopped after the gas in the chamber is completely replaced, and the powder sintering system can save protective gas consumption. In addition, the powder sintering system also has a small occupying space.

Other embodiments of the disclosure will be apparent to those skilled in the art from consideration of the specification and practice of the embodiments disclosed herein. It is intended that the specification and examples be considered as exemplary only, with the true scope and spirit of the embodiments being indicated by the following claims.

What is claimed is:

1. A powder sintering system, comprising:
a furnace body comprising a bottom and a side wall defining a funnel shaped chamber;
at least one first dispersing device located on the bottom of the furnace body, the at least one first dispersing device configured to centrifugally disperse powder from the bottom of the furnace body to the side wall of the furnace body;
at least one second dispersing device located on the side wall of the furnace body, the at least one second dispersing device configured to centrifugally disperse powder from the side wall of the furnace body to a center of the funnel shaped chamber;
a heating device located outside the furnace body; and
a gas introducing device supplying a protecting gas into the funnel shaped chamber.

2. The powder sintering system of claim 1, wherein an upper portion of the furnace body has a hollow column shaped structure, a lower portion of the furnace body has a hollow frustum shaped structure, and the hollow column shaped structure and the hollow frustum shaped structure are connected together to form the furnace body.

3. The powder sintering system of claim 1, wherein the at least one first dispersing device is located at a center of the bottom of the furnace body.

4. The powder sintering system of claim 1, wherein the at least one second dispersing device is adjacent to a top of the furnace body.

5. The powder sintering system of claim 1, wherein the at least one second dispersing device is a plurality of second dispersing devices located at a same height on the side wall of the furnace body relative to the bottom of the furnace body.

6. The powder sintering system of claim 5, wherein the plurality of second dispersing devices form one or more pairs of second dispersing devices, each pair of second dispersing devices having two opposing second dispersing devices opposite to each other with respect to a central axis of the furnace body.

7. The powder sintering system of claim 1, wherein each of the at least one first dispersing device and the at least one second dispersing device comprises a dispersing wheel and an actuator, the dispersing wheel is located inside the furnace body, and the actuator is located outside the furnace body for driving the dispersing wheel.

8. The powder sintering system of claim 1, wherein the gas introducing device comprises at least one intake pipe located on the side wall between a top of the furnace body and the at least one second dispersing device, the at least one intake pipe is angled downwardly towards the bottom wall along a direction defining an angle with a center axis of the funnel shaped chamber, and the angle of the at least one intake pipe is in a range between 0 degrees and 90 degrees.

9. The powder sintering system of claim 1, further comprising an exhaust device configured to discharge smoke or gas produced in the funnel shaped chamber in a sintering process, the exhaust device comprising a gas-solid separating unit, an automatic control valve, a gas buffer unit, and an exhaust pipe, wherein the gas-solid separating unit is located on a top of the furnace body, the gas buffer unit is located on an end of the gas-solid separating unit away from the furnace body, the exhaust pipe extends from an end of the gas buffer unit, and the automatic control valve is located on the exhaust pipe.

10. The powder sintering system of claim 1, further comprising a feed pipe, a tapered container, and a gas exchanging room, wherein the tapered container is connected to the funnel shaped chamber through the feed pipe, and the gas exchanging room is located at an end of the tapered container away from the furnace body.

11. A powder sintering system, comprising:
a furnace body comprising a bottom and a side wall defining a funnel shaped chamber with a closed structure;
at least one first dispersing device located on the bottom of the furnace body, the least one first dispersing device configured to centrifugally disperse powder from the bottom of the furnace body to the side wall of the furnace body;
a plurality of second dispersing devices located on the side wall, the second dispersing devices each configured to centrifugally disperse powder from the side wall of the furnace body to a center of the funnel shaped chamber;
a heating device located on outer surface of the outside the furnace body;
a gas introducing device supplying a protecting gas into the funnel shaped chamber;
an exhaust device configured to discharge flue smoke produced in the funnel shaped chamber in a sintering process;
a feed device located on a top of the furnace body; and
a discharge device located on a lower portion of the side wall of the furnace body to discharge the sintered powder from the funnel shaped chamber.

12. The powder sintering system of claim 11, wherein an upper portion of the furnace body has a hollow column shaped structure, a lower portion of the furnace body has a hollow frustum shaped structure, and the hollow column shaped structure and the hollow frustum shaped structure are connected together to form the funnel shaped chamber.

13. The powder sintering system of claim 11, wherein the at least one dispersing device is located at a center of the bottom of the furnace body.

14. The powder sintering system of claim 11, wherein the plurality of second dispersing devices are adjacent to the top of the furnace body.

15. The powder sintering system of claim 11, wherein the plurality of second dispersing devices are located at a same height on the side wall of the furnace body.

16. The powder sintering system of claim 15, wherein the plurality of second dispersing devices form one or more pairs of second dispersing devices, each pair of second dispersing devices having two opposing second dispensing devices opposite to each other with respect to a central axis of the furnace body.

17. The powder sintering system of claim 11, wherein each of the at least one first dispersing device and the at least two second dispersing devices comprises a dispersing wheel and an actuator, the dispersing wheel is located inside the furnace body, and the actuator is located outside the furnace body for driving the dispersing wheel.

18. The powder sintering system of claim 11, wherein the gas introducing device comprises a plurality of intake pipes located on the side wall of the furnace body between the top of the furnace body and the at plurality of second dispersing devices, each of the plurality of intake pipes is angled downwardly towards the bottom of the furnace body along a direction defining an angle with a center axis of the funnel shaped chamber, and the angle of the intake pipe is in between 0 degrees and 90 degrees.

19. The powder sintering system of claim 11, wherein the exhaust device comprises a gas-solid separating unit, an automatic control valve, a gas buffer unit, and an exhaust pipe, the gas-solid separating unit is located on the top of the furnace body, the gas buffer unit is located on one end of the gas-solid separating unit away from the furnace body, the exhaust pipe extends from an end of the gas buffer unit, and the automatic control valve is located on the exhaust pipe.

20. The powder sintering system of claim 11, wherein the feed device comprises a feed pipe, a tapered container, and a gas exchanging room, the tapered container is connected to the funnel shaped chamber through the feed pipe, and the gas exchanging room is located on at an end of the tapered container away from the furnace body.
